(19) United States
(12) Patent Application Publication
(10) Pub. No.: US 2007/0041587 A1
(43) Pub. Date: Feb. 22, 2007

(54) Digital audio broadcasting modem interface system for receiving multi-channel and its working method

(75) Inventor: Seung Joo Yoon, Seoul (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: C&S TECHNOLOGY CO., LTD., Seoul (KR)

(21) Appl. No.: 11/332,906

(22) Filed: Jan. 17, 2006

(30) Foreign Application Priority Data
Aug. 19, 2005 (KR) 10-2005-0076174

(51) Int. Cl. H04H 5/00

(52) U.S. Cl. 381/2

(57) ABSTRACT

Disclosed is a DAB (Digital Audio Broadcasting) modem interface for receiving multi-channel, which is capable of receiving two channels at once by providing a sub-channel filtering function to the DAB modem interface, and a method of operating the same. The DAB modem interface includes a serial interface for capturing channel data in bit stream data output from the DAB modem, buffer switching means for classifying the channel data captured by the serial interface for each channel and storing the classified channel data in two buffers assigned for each channel, and sub-channel filtering means for performing a sub-channel filtering operation of comparing a channel value acquired from the multimedia processor with a sub-channel ID value acquired in the course of capturing of the channel data, and generating control signals for controlling the serial interface to provide information on two channels to be captured and the buffer switching means to store data into the two buffers.

### BACKGROUND OF THE INVENTION

1. Field of the Invention

The present invention relates to a digital audio broadcasting (DAB) modem interface for receiving multi-channel and a method of operating the same, and more particularly, to a DAB modem interface for receiving multi-channel, which is capable of receiving two channels at once by providing a sub-channel filtering function to the DAB modem interface, and a method of operating the same.

2. Description of the Related Art

With the rapid development of broadcasting techniques, a variety of services have been developed and provided to users. Up to now, when a user views terrestrial broadcasting programs while moving, he receives images of poor quality and a receipt state of images is very inferior. To overcome such a problem, there rise a multi-carrier broadcasting system and a satellite broadcasting system as techniques allowing users to view broadcasting programs while moving.

In the case of terrestrial broadcasting using the multi-carrier broadcasting system for mobile broadcasting, a digital television broadcasting and a digital radio broadcasting are being now serviced in Europe according to a DVB (Digital Video Broadcasting) system and a DAB (Digital Audio Broadcasting) system, respectively, and a DMB (Digital Multimedia Broadcasting) system for providing a multimedia broadcasting has been recently studied and developed all over the world.

The DAB and DMB systems have a merit in that they may provide good sound quality due to low noises and allow use of an efficient frequency spectrum due to multiplexing of various audio and data services into a single transmission channel. A variety of channels of the DMB system provide various kinds of information services with moving pictures and audio mixed, as well as a general data service and a traffic information service.

FIG. 1 is a block diagram of a conventional DMB system, where the DMB system is generally divided into a DAB modem 10 for receiving DAB data, a multimedia processor 20 for processing the DAB data, and a DAB modem interface 30 for interfacing between the DAB modem 10 and the multimedia processor 20.

DAB modem 10 includes an RF 10a, a BB (Baseband) 10b and a microcomputer loc, the multimedia processor 20 includes a DMB demultiplexer 20a and a codec 20b, and the DAB modem interface 30 includes a serial interface 30a and is connected to a memory 40.

The DAB modem interface 30 generally has two interfacing functions.

First, the DAB modem interface 30 has an instruction processing interfacing function to the DAB modem 10. This instruction processing interfacing function is to provide information on sub-channels to be detected from the DAB modem 10 to the multimedia processor 20. At this time, the multimedia processor 20 transmits information on change of channels and so on, provided by users, to the DAB modem 10.

Second, the DAB modem interface 30 has an interfacing function of bit stream data received from the DAB modem 10. This bit stream data interfacing function is to transmit the bit stream data to the multimedia processor 20 through the serial interface 30a of the DAB modem interface 30. At this time, the multimedia processor 20 decodes the bit stream data received therein and displays the decoded data on an LCD (Liquid Crystal Display) at a user level.

When the DMB system is constructed as shown in FIG. 1, the DAB modem interface 30 writes the bit stream data aligned in the unit of word into the memory 10 without performing a separate sub-channel ID filtering operation for the bit stream data received from the DAB modem 10.

The memory 10 is comprised of two buffers for distinguishing between read/write operations. When a data writing operation for one buffer is completed, a data writing operation for the other buffer is started. The multimedia processor 20 reads the bit stream data written into the buffers and then performs a sub-channel ID filtering operation using specific software.

However, if the sub-channel ID filtering operation depends on the specific software, the quantity of computation of a CPU is increased. That is, the CPU has to read all the bit stream data written into the buffers without performing a hardware filtering operation. Accordingly, there arises a problem of needless increase of a size of a memory occupied by the CPU.

Such a problem may result in degradation of system performance. Accordingly, there is a need to design and verify a system for performing a filtering operation for sub-channels and filtering one or more channels efficiently with reduction of quantity of needless computation of the CPU and without increase of the size of memory occupied by the CPU.

### SUMMARY OF THE INVENTION

The present invention has been made to overcome the above problem, and it is an object of the present invention to provide a system for receiving a multi-channel, which is capable of receiving two channels at once by providing a sub-channel filtering function to a DAB modem interface, and a method of operating the same.

In order to accomplish the above objects, the present invention provides a DAB (Digital Audio Broadcasting) modem interface for receiving a multi-channel, the DAB modem interface interfacing between a DAB modem and a multimedia processor in a DMB (Digital Multimedia Broadcasting) system, comprising: a serial interface for capturing channel data in bit stream data output from the DAB modem; buffer switching means for classifying the channel data captured by the serial interface for each channel and storing the classified channel data in two buffers assigned for each channel; and sub-channel filtering means for performing a sub-channel filtering operation of comparing a channel value acquired from the multimedia processor with a sub-channel ID value acquired in the course of capturing of the channel data, and generating control signals for controlling the serial interface to provide information on two channels to be captured and the buffer switching means to store data into the two buffers.

Preferably, the control signals are generated by comparing the channel value acquired from the multimedia processor with a sub-channel ID value acquired through a separate sub-channel ID port.

Preferably, the control signals are generated when the channel value acquired from the multimedia processor is equal to the sub-channel ID value acquired in the course of capturing of the channel data.

Preferably, the buffer switching means has a double buffer structure for assigning buffers separately according to a channel classification in order to store data for each channel.

Preferably, the buffer switching means comprises: a CH0_CH1 switching block for determining whether the channel data input based on the control signals correspond to which of a sub-channel 0 and a sub-channel 1; a BUF0_BUF1 switching block for determining whether the channel data corresponding to the sub-channel 0 and the sub-channel 1 determined by the CH0_CH1 switching block are stored in which of BUF0 and BUF1, which are the two buffers assigned for each channel; and a FIFO control block for determining whether the data processed in the BUF0_BUF1 switching block are loaded in the buffers or are read by the multimedia processor based on buffer control signals generated by the BUF_BUF1 switching block and buffer control signals transmitted from the multimedia processor via an APB (Advanced Peripheral Bus).

Preferably, the buffer control signals generated by the BUF0_BUF1 switching block are signals for data writing operation and the buffer control signals transmitted from the multimedia processor to the FIFO control block via the APB are signals for data reading operation.

Preferably, the BUF0_BUF1 switching block controls such that, when the buffer data writing operation for one of the BUF0 and the BUF1, which are the two buffers assigned for each channel, is completed, the buffer data writing operation for the other of the BUF0 and the BUF1 is performed.

Also, in order to accomplish the above objects, the present invention provides a method of operating a DAB modem interface for receiving a multi-channel, comprising the steps of: performing a sub-channel filtering operation for determining whether a sub-channel value of a received transport stream is equal to a sub-channel 0 or a sub-channel 1 set by a user through a CPU; if the sub-channel value of the received transport stream is equal to the sub-channel 0 or the sub-channel 1 set by the user, by a CH0_CH1 switching block, determining whether the sub-channel value of the received transport stream corresponds to which of the sub-channels 0 and 1 and providing a buffer control signal and values of a buffer address and buffer data of a corresponding channel to the BUF0_BUF1 switching block; by the BUF0_BUF1 switching block, determining whether data of the channel are stored in which of BUF0 and BUF1 (BUF0/BUF1 of channel 0 and BUF0/BUF1 of channel 1), which are two buffers assigned for each channel; and by a FIFO control block, determining whether the data processed in the BUF0_BUF1 switching block are loaded in the buffers or are read by a multimedia processor based on buffer control signals generated by the BUF_BUF1 switching block and buffer control signals transmitted from the multimedia processor via an APB.

Also, in order to accomplish the above objects, the present invention provides a DAB modem interface system for receiving a multi-channel, wherein data exchange between the DAB modem interface system and a multimedia processor at a decoder stage is implemented through a bus interface, and information on completion of a buffer data writing operation for one buffer of a double buffer for each channel is provided from the DAB modem interface system to the multimedia processor through an interrupt signal.

### BRIEF DESCRIPTION OF THE DRAWINGS

The above and/or other objects and advantages of the present invention will become apparent and more readily appreciated from the following description of the embodiments, taken in conjunction with the accompanying drawings of which:

FIG. 1 is a block diagram of a conventional DMB system;

FIG. 2 is a block diagram of a DMB system according to an embodiment of the present invention;

FIG. 3 is a view illustrating a buffer switching process in FIG. 2; and

FIG. 4 is a view illustrating details of the buffer switching process in FIG. 3.

### DETAILED DESCRIPTION OF THE PREFERRED EMBODIMENT

Hereinafter, the structure and operation of preferred embodiments of the present invention will be described in detail with reference to the accompanying drawings.

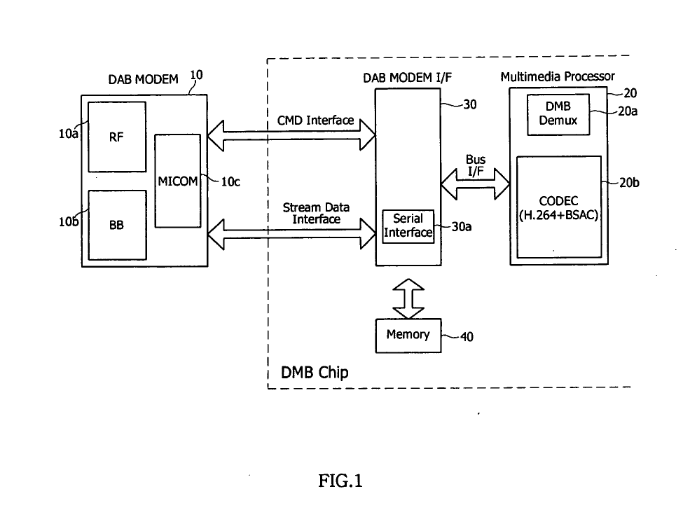

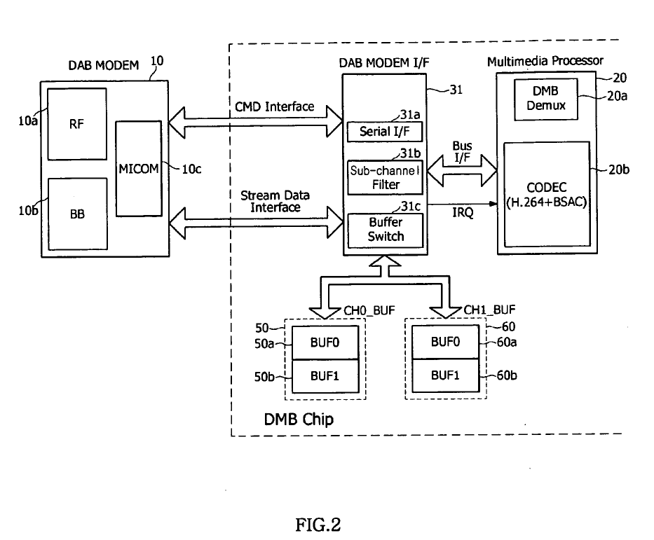

FIG. 2 is a block diagram of a DMB system according to an embodiment of the present invention. A DMB system according to the embodiment of the present invention is different in a structure of the DAB modem interface 31 from the conventional DMB system shown in FIG. 1.

A DAB modem interface 31 suggested in the present invention generally includes a serial interface 31a, a sub-channel filter 31b and a buffer switch 31c. In addition, two switching buffers CH0_BUF 50 and CH1_BUF 60, which are assigned for each channel and into which data of two different channels are loaded, are connected to the DAB modem interface 31.

The serial interface 31a captures bit stream data output from a DAB modem 10 having the same structure as that of the conventional DMB system.

The buffer switch 31c classifies channel data, which are captured by the serial interface 31a, for each channel and stores the classified channel data in the two switching buffers 50 and 60 assigned for each channel.

The sub-channel filter 31b performs a sub-channel filtering operation of comparing a channel value acquired from the multimedia processor 20 with a sub-channel ID value acquired during the capturing of the bit stream data and generates control signals for controlling the serial interface 31a to provide information on the two channels to be captured and the buffer switch 31c to store data into the two switching buffers.

Now, operation of each of circuits in the DAB modem interface 31 will be described.

The serial interface 31a performs an operation of capturing data output from the DAB modem 10 using an internal shift register. Here, a detailed timing of the data capturing operation is different depending on format of output from the DAB modem 10 and is determined in synchronization with an input signal corresponding to a synchronization signal. At this time, a sub-channel ID value is acquired in the course of data capturing (or a sub-channel ID value is acquired through a separate sub-channel ID port). Whether or not the data are to be captured by the serial interface 31a is decided when the sub-channel filter 31b determines that the acquired sub-channel ID value is equal to channel information set by a user, which will be described. Output of the serial interface 31a is aligned in the unit of word and stored in a buffer.

The sub-channel filter 31b performs a sub-channel filtering operation of comparing a channel value acquired from the multimedia processor 20 at a decoder stage (that is, a channel value set by a user) with a sub-channel ID value acquired in the course of data capturing or a sub-channel ID value acquired through a separate sub-channel ID port and generates control signals MAT_CH0 and MAT_CH1 for controlling the serial interface 31a to provide information on the two channels to be captured and the buffer switch 31c to store data into the two switching buffers.

In this manner, the control signals MAT_CH0 and MAT_CH1 are generated when the two channels set by the user are equal to channels of data which are being currently received, and then is transmitted to the serial interface 31a and the buffer switch 31c.

The serial interface 31a captures the channel data based on the control signals MAT_CH0 and MAT_CH1.

The buffer switch 31a determines into which of the switching buffers CH1_BUF 50 and CH0_BUF 60 the captured channel data are written. More specifically, the buffer switch 31a classifies the channel data captured by the serial interface 31a for each channel based on the control signals MAT_CH0 and MAT_CH1 output from the sub-channel filter 31b and controls an operation of writing the channel data into the switching buffer CH0_BUF 50 or CH1_BUF 60.

The switching buffers CH0_BUF 50 and CH1_BUF 60 have a double buffer structure composed of two buffers to allow a buffer data writing operation by the DAB modem interface 31 and a buffer data reading operation by the multimedia processor 20 to be performed simultaneously. In other words, while performing an operation of reading the channel data loaded in one switching buffer for which the buffer data writing operation is completed, the multimedia processor 20 continues to perform the buffer data writing operation for the other switching buffer. For example, assuming that the channel data are written into BUF0 and BUF1 of the switching buffer CH0_BUF 50 when the control signal MAT_CH0 is set in the course of outputting of the sub-channel filter 31b, while the buffer data writing operation for the BUF0 is completed and the buffer data writing operation for the BUF1 is performed, the multimedia processor 20 can read the buffer data loaded in the BUF0.

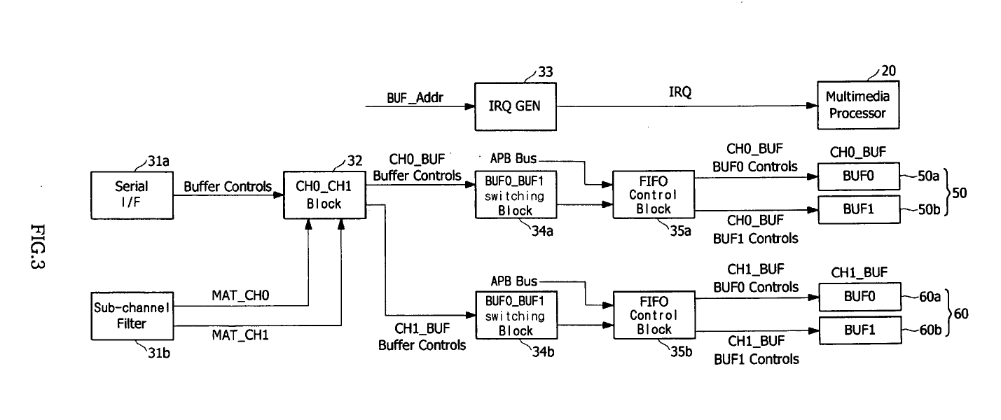

FIG. 3 is a view illustrating a buffer switching process in FIG. 2, where the buffer switch 31c for performing the buffer switching operation includes a CH0-CH1 switching block 32, BUF0_BUF1 switching blocks 34a and 34b, and FIFO control blocks 35a and 35b.

Referring to FIG. 3, the sub-channel filter 31b monitors a channel ID value of transport stream (TS) data received therein and determines whether or not a sub-channel value of the data received from the serial interface 31a is equal to a channel value set by the user. If equal, a shift enable signal is transmitted to the serial interface 31a.

If the channel set by the user is equal to an actual sub-channel channel value of the TS data, the CH0_CH1 switching block 32 determines whether the channel set by the user corresponds to which of a sub-channel 0 and a sub-channel 1, and then provides buffer control signals, buffer addresses and buffer data values to the BUF0_BUF1 switching blocks 34a and 34b.

If the channel set by the user is not equal to the sub-channel channel value of the TS data, the CH0_CH1 switching block 32 provides a value “not active” of the buffer control signals and a value “0” of the buffer addresses and the buffer data to the BUF0_BUF1 switching blocks 34a and 34b.

The BUF0_BUF1 switching blocks 34a and 34b determine whether data of a corresponding channel are stored in which of the BUF0 and BUF1.

The FIFO control blocks 35a and 35b determine whether the data processed in the BUF0_BUF1 switching blocks 34a and 34b are loaded in the switching buffers 50 and 60 or are read by the multimedia processor 20 at the decoder stage. In other words, only ones selected of the buffer control signals generated by the BUF_BUF1 switching blocks 34a and 34b and buffer control signals transmitted from the multimedia processor 20 at the decoder stage via an APB (Advanced Peripheral Bus) have to be applied to the switching buffers 50 and 60. Such an application of the buffer control signals is controlled by the FIFO control blocks 35a and 35b. In this case, the buffer control signals generated by the BUF0_BUF1 switching blocks 34a and 34b are signals for data writing operation and the buffer control signals transmitted from the multimedia processor 20 via the APB are signals for data reading operation.

When the data writing operation for the BUF1 is completed and a buffer full interrupt event occurs in the BUF1, while the data are stored in the BUF0, the multimedia processor 20 reads data of the BUF1.

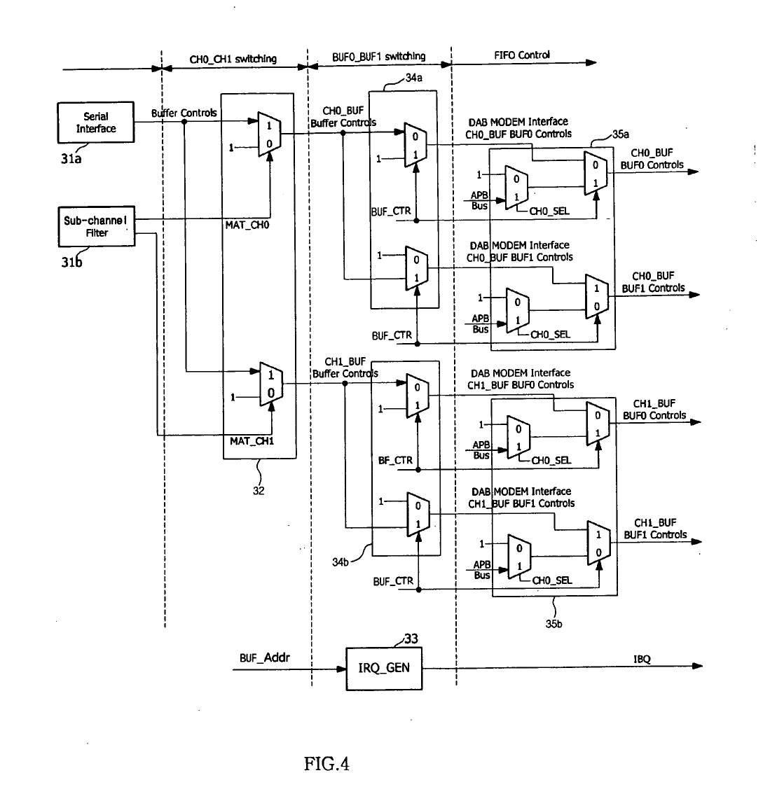

FIG. 4 is a view illustrating details of the buffer switching process in FIG. 3.

Referring to FIG. 4, the buffer control signals generated by the serial interface 31a are applied to the buffer switch 31c. The CH0-CH1 buffer switching block 32 of the buffer switch 31c determines whether the data correspond to which channel. At this time, such determination is performed based on the control signals MAT_CH0 and MAT_CH1 generated by the sub-channel filter 31b.

When such determination is completed, the BUF0_BUF1 switching blocks 34a and 34b determine whether the data are written into which buffer.

Whenever an address value applied to the buffer overflows in the BUF0_BUF1 switching blocks 34a and 34b, a BUF_CTR signal for controlling the buffer switching operation is toggled, and an interrupt signal IRQ is enabled by an IRQ_GEN circuit 33 and is transmitted to the multimedia processor 20 at the decoder stage. Based on the enabled interrupt signal IRQ, the multimedia processor 20 performs the buffer data reading operation. At this time, without performing the buffer data writing operation for one buffer for which the buffer data reading operation is performed, the buffer data writing operation for the other buffer is performed.

From the point of view of authority limit of the buffer address, the DAB modem interface 31 can perform-only the buffer data writing operation and the multimedia processor 20 can perform only the buffer data reading operation. Accordingly, when the multimedia processor 20 performs the buffer data reading operation for one buffer, the DAB modem interface 31 performs the buffer data writing operation for the other buffer.

In short, when the DAB modem interface 31 completes the buffer data writing operation for the BUF0, the BUF0_BUF1 switching blocks 34a and 34b immediately performs the buffer data writing operation for the BUF1.

When the buffer data writing operation for the corresponding buffer is performed, the buffer control signals generated by the DAB modem interface 31 are applied to the buffer. In addition, when the buffer data reading operation for the corresponding buffer is performed, the buffer control signals transmitted from the multimedia processor 20 via the APB are applied to the buffer.

FIFO control blocks 35a and 35b select one of the two kinds of above-mentioned buffer control signals and apply the selected one to the buffer. Here, CH0_SEL and CH1_SEL signals used as a selection criterion are control signals produced by decoding addresses transmitted via the APB.

SRAMs in a DMB chip are employed as the buffers connected to the DAB modem interface 31. In addition, two buffers for each channel are used in order to perform the buffer data reading/writing operations simultaneously. Since the SRAMs in the DMB chip require a small area in the side of a chip size, additional required buffers in the present invention over the conventional technique raise no problem.

As apparent from the description, according to the present invention, the DAB modem interface for receiving multi-channel and the method of operating the same have advantages as follows:

First, since two channels can be simultaneously received, a user can receive a traffic information service by a data broadcasting or TPEG (Transport Protocol Expert Group) simultaneously while receiving the DMB broadcasting service.

Second, since the buffer data writing/reading operations are performed in the buffers after sub-channels are filtered in the DAB modem interface module, the size of memory can be further reduced as compared to those in the conventional techniques.

Third, since the sub-channel filtering operation is directly performed by hardware, the computation quantity of a CPU can be reduced.

Fourth, since change of sub-channels by software is reflected in hardware, flexibility of the channel filtering by software can be maintained.

The preferred embodiment of the present invention have been shown and described only for illustration, not limitation. It will be appreciated by those skilled in the art that changes may be made in these embodiments without departing from the principles and spirit of the invention, the scope of which is defined in the appended claims and their equivalents.

1. A DAB (Digital Audio Broadcasting) modem interface for receiving a multi-channel, the DAB modem interface interfacing between a DAB modem and a multimedia processor in a DMB (Digital Multimedia Broadcasting) system, comprising:
a serial interface for capturing channel data in bit stream data output from the DAB modem;
buffer switching means for classifying the channel data captured by the serial interface for each channel and storing the classified channel data in two buffers assigned for each channel; and
sub-channel filtering means for performing a sub-channel filtering operation of comparing a channel value acquired from the multimedia processor with a sub-channel ID value acquired in the course of capturing of the channel data, and generating control signals for controlling the serial interface to provide information on two channels to be captured and the buffer switching means to store data into the two buffers.

2. The DAB modem interface according to claim 1, wherein the control signals are generated by comparing the channel value acquired from the multimedia processor with a sub-channel ID value acquired through a separate sub-channel ID port.

3. The DAB modem interface according to claim 1, wherein the control signals are generated when the channel value acquired from the multimedia processor is equal to the sub-channel ID value acquired in the course of capturing of the channel data.

4. The DAB modem interface according to claim 1, wherein the buffer switching means has a double buffer structure for assigning buffers separately according to a channel classification in order to store data for each channel.

5. The DAB modem interface according to claim 1, wherein the buffer switching means comprises:
a CH0_CH1 switching block for determining whether the channel data input based on the control signals correspond to which of a sub-channel 0 and a sub-channel 1;
a BUF0_BUF1 switching block for determining whether the channel data corresponding to the sub-channel 0 and the sub-channel 1 determined by the CH0_CH1 switching block are stored in which of BUF0 and BUF1, which are the two buffers assigned for each channel; and
a FIFO control block for determining whether the data processed in the BUF0_BUF1 switching block are loaded in the buffers or are read by the multimedia processor based on buffer control signals generated by the BUF_BUF1 switching block and buffer control signals transmitted from the multimedia processor via an APB (Advanced Peripheral Bus).

6. The DAB modem interface according to claim 5, wherein the buffer control signals, generated by the BUF0_BUF1 switching block, are signals for data writing operation and the buffer control signals transmitted from the multimedia processor to the FIFO control block via the APB are signals for data reading operation.

7. The DAB modem interface according to claim 5, wherein the BUF0_BUF1 switching block controls such that, when the buffer data writing operation for one of the BUF0 and the BUF1, which are the two buffers assigned for each channel, is completed, the buffer data writing operation for the other of the BUF0 and the BUF1 is performed.

8. A method of operating a DAB modem interface for receiving a multi-channel, comprising the steps of:
performing a sub-channel filtering operation for determining whether a sub-channel value of a received transport stream is equal to a sub-channel 0 or a sub-channel 1 set by a user through a CPU;
if the sub-channel value of the received transport stream is equal to the sub-channel 0 or the sub-channel 1 set by the user, by a CH0_CH1 switching block, determining whether the sub-channel value of the received transport stream corresponds to which of the sub-channels 0 and 1 and providing a buffer control signal and values of a buffer address and buffer data of a corresponding channel to the BUF0_BUF1 switching block;
by the BUF0_BUF1 switching block, determining whether data of the channel are stored in which of BUF0 and BUF1 (BUF0/BUF1 of channel 0 and BUF0/BUF1 of channel 1), which are two buffers assigned for each channel; and
by a FIFO control block, determining whether the data processed in the BUF0_BUF1 switching block are loaded in the buffers or are read by a multimedia processor based on buffer control signals generated by the BUF_BUF1 switching block and buffer control signals transmitted from the multimedia processor via an APB.

9. A DAB modem interface system for receiving a multi-channel, wherein data exchange between the DAB modem interface system and a multimedia processor at a decoder stage is implemented through a bus interface, and information on completion of a buffer data writing operation for one buffer of a double buffer for each channel is provided from the DAB modem interface system to the multimedia processor through an interrupt signal.

10. The DAB modem interface according to claim 2, wherein the control signals are generated when the channel value acquired from the multimedia processor is equal to the sub-channel ID value acquired in the course of capturing of the channel data.
